(19) United States
(12) Patent Application Publication
(10) Pub. No.: US 2019/0393706 A1
(43) Pub. Date: Dec. 26, 2019

(54) BATTERY CHARGING STATION WITH COMMUNICATION CAPABILITIES

(71) Applicant: TECHTRONIC CORDLESS GP, Anderson, SC (US)

(72) Inventor: Mark Huggins, Anderson, SC (US)

(21) Appl. No.: 16/447,145

(22) Filed: Jun. 20, 2019

Related U.S. Application Data
(60) Provisional application No. 62/687,615, filed on Jun. 20, 2018.

(51) Int. Cl. H02J 7/00; H01M 2/10; H02J 7/02

(52) U.S. Cl. CPC H02J 7/0052; H02J 7/025; H01M 2/1016

(57) ABSTRACT

A method for monitoring and controlling devices at a work site includes storing sensor data collected during operation of a work site device in a memory of the work site device. The charging station hub device transmits operational characteristics request to the work site device. The work site device determines operational characteristics of the work site device based on the sensor data stored in the memory of the work site device. The work site device transmits the operational characteristics of the work site device to the charging station hub device via the established connection supported by the work site device and the charging station hub device. The charging station hub transmits the operational characteristics to a mobile user device via the network.

### CROSS-REFERENCE TO RELATED APPLICATION

This application claims priority to U.S. Provisional Patent Application No. 62/687,615 filed on Jun. 20, 2018, the entire contents of which are hereby incorporated by reference.

### FIELD OF INVENTION

The invention relates to a battery charging system, and particularly a battery charging system having short and long range communication capability for communicating with intelligent tools.

### SUMMARY

In some embodiments, systems and methods are provided for a battery charging station with communication capabilities. The battery charging station may be portable and may be referred to as a charging station hub or tool control hub. The charging station hub communicates with various devices, for example, devices that are utilized in a work environment, work site, or construction site. A communication module in the charging station hub has a controller that can monitor, control, and/or secure the work site devices. In some embodiments, the communication module and one or more devices, such as a battery charger, may be integrated or packaged in a housing, as in the charging station hub. In some embodiments, the communication module may be packaged or integrated in other types of devices, such as a job sight radio, a light, or a garage door opener, to function as a tool control hub. In yet other embodiments, the communication module may be included in a standalone housing and communicate wirelessly with devices distributed in the work environment to function as a tool control hub. However, all of these embodiments include the communication module comprising the controller and all of these embodiments may be referred to as the charging station hub or the tool control hub.

Devices that are monitored and managed by the charging station hub include, for example, power tools, battery packs, battery chargers, job site radios, lights, speakers, vacuums, fans, meters, scales, doors, locks, vehicles, and other work related equipment. For example, the charging station hub monitors and manages the charging of battery packs and/or the usage of battery packs that are connected to power tools. In some embodiments, the work site devices have components such as sensors, memory, and/or electronic processors. The devices provide data to the charging station hub for determining device status and/or operational characteristics of the devices by the controller in the communication module. The work site devices include wireless communication interfaces and may communicate the data, device status, and/or operational characteristics to the communication module of the charging station hub. The data may be utilized by the controller of the communication module in the charging station hub to manage the job site devices and the job site environment and/or to communicate information about the work site devices to a user device. The work site devices may also implement security features such as a lock feature or alarm feature to prevent theft of the work site devices. For example, a battery pack removed from a work site may lock its charging function and generate an audible or visible alarm when communication with the charging station hub is lost because it is outside of a communication range. The devices in communication with the communication module may be referred to as work site devices; however, the disclosure is not limited to devices used at a work site and any suitable device, tool, or equipment may communicate with the communication module and be monitored and managed by the charging station hub.

Transceivers in the communication module are able to communicate with the devices or tools in the work environment as well as with mobile user devices (e.g., a smart phones, tablets, laptops, personal computers, or the like), and remote servers. In some embodiments, a mobile user device may be configured with a charging station hub software application that serves to inform users of work site device issues and allows the users to configure and/or control the charging station hub and/or the work site devices through communications with the charging station hub. Remote servers may also be accessed by the communication module and/or the mobile user device. The remote servers provide data including work site device or manufacturer information for use by the controller of the communication module or by the user device for analysis and management of the work site devices.

In some embodiments, the charging station hub may be equipped with various sensors to detect a status of the charging station hub, for example, to detect safety hazards, physical damage to the housing or components of the hub, theft of the hub, and/or operational impairments. For example the charging station hub may have heat, pressure, motion, or material breakage sensors. The charging station hub may include user interfaces for generating audible or visible alarms in response to specified sensor output to inform users or deter theft or damage to the charging station hub. The communication module of the charging station hub may also communicate alerts as to the status of charging station hub via a wireless communication interface to a user's device such as a smart phone or laptop. In some embodiments, work site devices may periodically communicate operational characteristics to the charging station hub.

A method is provided for monitoring and controlling devices at a work site. The method includes collecting sensor data in a work site device during operation of the work site device and storing the sensor data in a memory of the work site device. A direct connection is established and supported by the work site device and the charging station hub device. The charging station hub device transmits the operational characteristics request to the work site device. The work site device determines operational characteristics of the work site device based on the sensor data stored in the memory of the work site device. The work site device transmits the operational characteristics of the work site device to the charging station hub device via the established connection supported by the work site device and the charging station hub device. The charging station hub transmits the operational characteristics to a mobile user device via the network.

Other features and aspects of the invention will become apparent by consideration of the following detailed description and accompanying drawings.

### BRIEF DESCRIPTION OF THE DRAWINGS

FIG. 1 is an exterior view of a portable charging station hub that includes battery and phone chargers.

FIG. 2 is an interior view of the charging station hub shown in FIG. 1.

FIG. 3 illustrates a standalone tool control hub.

FIG. 4 is a schematic diagram illustrating a charging station hub and work site device management features.

FIG. 5 is a block diagram of a charging station hub and work site device management system.

FIG. 6 is a block diagram of an example job site device for use with the charging station hub.

FIG. 7 is a diagram of communication connections in a charging station hub management system.

FIG. 8 is a flow chart for monitoring a work site device utilizing a charging station hub.

FIG. 9 illustrates a charging station hub that monitors work site devices in a job site environment.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

Also, it is to be understood that the phraseology and terminology used herein is for the purpose of description and should not be regarded as limiting. Additionally, as used herein with a list of elements, “and/or” is intended to mean one or a combination of the listed elements. For example, “A, B, and/or C” should be understood to include any of A, B, C, AB, BC, AC, or ABC.

It should be noted that a plurality of hardware and software based devices, as well as a plurality of different structural components may be utilized to implement aspects of the invention. Furthermore, specific configurations described or illustrated in the drawings are intended to exemplify independent embodiments of the invention and that other alternative configurations are possible. The terms “controller”, “processor”, “central processing unit” and “CPU” are interchangeable unless otherwise stated. Where the terms “controller”, “processor”, “central processing unit” or “CPU” are used as identifying a unit performing specific functions, it should be understood that, unless otherwise stated, those functions can be carried out by a single processor or multiple processors arranged in any form, including parallel processors, serial processors, tandem processors or cloud processing/cloud computing configurations.

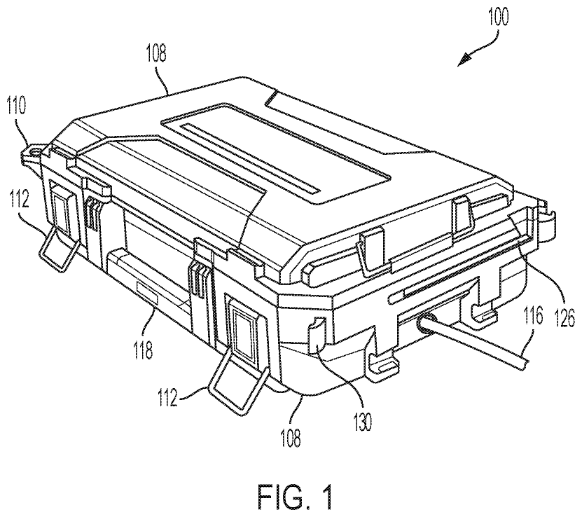

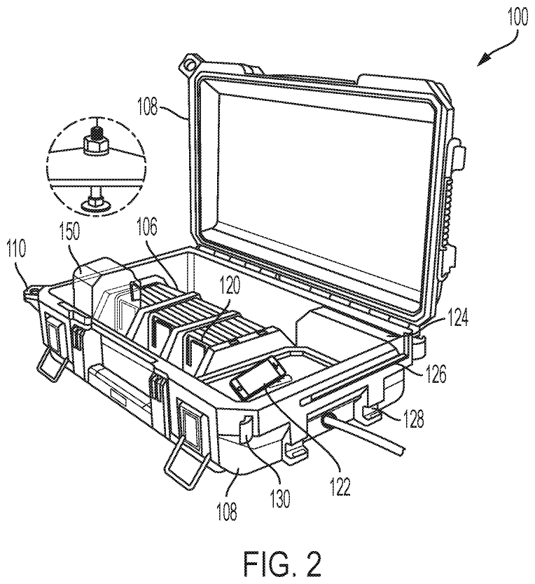

FIGS. 1 and 2 include exterior and interior views of a portable charging station hub for use in a work environment, or at a work site or construction site, for example. However, the disclosure is not limited in this regard, and the portable charging station hub may be utilized in any suitable location. The portable charging station hub includes battery chargers and mobile user device chargers. Shown in FIGS. 1 and 2 are a charging station hub 100 including a housing 108, a communication module 124, a subminiature version A (SMA) or SNA connector and antenna 126, a power cord 116, battery chargers 120, and a mobile device charging module 122. Also shown in FIGS. 1 and 2 is a battery pack 150 received by one of the battery chargers 120.

The housing 108 includes one or more features for use in a work environment. For example, the housing 108 is made of a durable material and comprises portable case having a base, lid coupled to the base by a hinge, latching mechanisms 112, a lock 110, a carrying handle 118, a cord wrap 130, and a receptacle 128 that is compatible with other storage devices. One or more of the battery charger 120, the communication module 124, and the mobile device charging module 122 is semi-permanently installed in the housing 108 utilizing hardware fasteners 106.

The charging station hub 100 includes a terminal block configured to receive power from an external power source 204, such as a standard 120 VAC power outlet via the power cord 116. The terminal block directs power, via a transformer to a battery charger 120, the mobile charging module 122, the communication module 124, user interface components that may include LEDs and a speaker, and one or more various sensors. The sensors include, for example, heat sensors that sense when the battery charger 120 or battery pack 150 over heats; motion sensors that sense when the hub 100 is being moved; pressure, deformation, or breakage sensors that sense when the hub is damaged or when a break-in attempt occurs. The charging station hub 100 communicates an alert via the user interface components as a result of one of the sensors detecting a specified condition. Alternatively or in addition, the communication module 124 includes a battery interface and is powered by battery cells rather than AC power.

The communication module 124 includes one or more wireless and/or wired communication interfaces for communicating with work site devices, user devices (e.g., mobile smart phone, smart assistant, or laptop), and/or network devices such as a remote server. The user devices may be referred to as mobile user devices. In some embodiments, communications between the battery pack 150 and the communication module 124 occur via connected reciprocal wired terminals in the battery pack 150 and the charger 120 and via connected reciprocal wired terminals in the charger 120 and the communication module 124. The communication module 124 may also include various physical communication interfaces and use various communication protocols for short and/or longer distance communication including communications in wireless personal area networks, wired or wireless local area networks, and/or wired or wireless wide area networks. For example, Bluetooth communications may be utilized between a work site device (e.g., the battery pack 150) and the communication module 124. For example, Bluetooth communications may be utilized when the battery pack 150 is received in the battery charger 120, when the battery pack is located separately at the job site, and when it is located at the work site and connected to a power tool. In some embodiments, the communication module 124 and/or work site devices (e.g., the battery pack 150 or the charger 120) include a Bluetooth pairing button that initiates pairing of Bluetooth communication interfaces in the communication module 124 and/or the work site devices to enable wireless communication between the Bluetooth communication interfaces. The communication module 124 may also have communication interfaces for communicating via a wireless local area network such as a Wi-Fi network, or a wide area network, such as a cellular network and/or a wired network.

The charger 120 includes a charger controller that has an electronic processor and memory storing instructions that are executed by the electronic processor to carry out the functionality of the charger controller. For example, the charger controller controls functions of the charger 120 and enables communication between the charger 120 and the battery pack 150 and between the charger 120 and the communication module 124. The charger 120 further includes a charging circuit within a charger housing that is controlled by the charger controller to provide charging current to the battery pack 150 to charge the battery cells of the battery pack. In some embodiments, the battery pack charger 120 may be a multi-port charger. The mobile charging module 122 may be a charging pad or mat that is operable to charge a mobile device by inductive charging.

The battery pack 150 includes a housing, a work site device interface (e.g., a power tool interface), a battery charger interface, and a plurality of cells arranged in a series, parallel or series-parallel combination. The battery pack 150 further includes a battery pack controller that has an electronic processor and memory storing instructions that are executed by the electronic processor to carry out the functions of the battery pack controller. The battery pack 150 is configured to be attached to a work site device, for example, a power tool to provide power for use of the work site device and to be attached to the battery charger 120 for recharging the battery pack 150. The battery pack 150 includes sensors (e.g., current and voltage sensors) and communication interfaces to communicate with the communication module 124, the charger 120, and/or a mobile user device. Data obtained from the sensors may be utilized to determine operational characteristics of the battery pack 150 or of a work site device such as a power tool attached to the battery pack 150. One or more of the battery pack 150, the communication module 124, or the mobile user device determines the operational characteristics based on the sensor data. The operational characteristics may include, for example, battery pack current output, voltage across the battery cells, torque applied by a power tool attached to the battery pack 150, a current trace indicating a type of power tool connected to the battery pack 150 (e.g., impact driver, hammer drill, reciprocating saw or circular saw), battery pack charge time estimation, charge rate, and battery pack charge level. Stored data or data obtained from a server, for example may also contribute to determination of the operational characteristics. A charging station hub software application, for example a mobile application running on the mobile user device display the operational characteristics on a graphical user interface of the software application. The communication module 124 monitors charge status, controls charging of the battery pack 150 by the charger 120, and/or controls operation of a work site device attached to the battery pack 150 based on the operational characteristics.

The battery pack 150 and/or other work site devices communicate directly with the communication module 124 or with the mobile user device over a wireless communication network such as Bluetooth®, Wi-Fi™, and the like. The battery pack 150 and/or other work site devices may also communicate with the communication module 124 or the mobile user device via any suitable wide area network such as a cellular network, Ethernet network, the Internet and the like. In some embodiments, the communication module 124 and/or the mobile user device communicate via a network with a server, which may be an application server.

Additional information about battery packs with wireless communication, battery chargers, and power tools, among other things, may be found in U.S. patent application Ser. No. 15/461,067, which was filed Mar. 16, 2017, and which is incorporated by reference herein in its entirety.

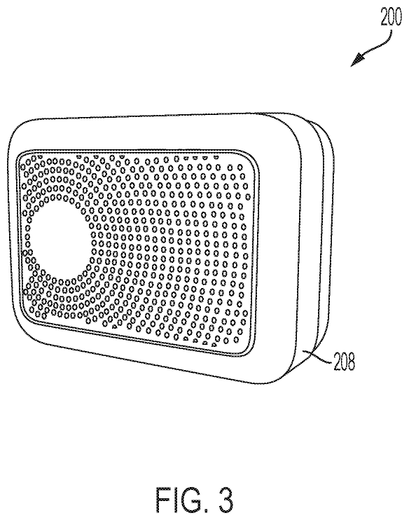

FIG. 3 illustrates a standalone tool control hub. Referring to FIG. 3, a standalone tool control hub 200 includes a housing 208, the communication module 124, a subminiature version A (SMA) or SNA connector and antenna 126.

The standalone tool control hub 200 differs from the charging station hub 100 in that the standalone hub 200 does not include integrated or packaged work site devices of the charging station hub 100 (i.e., the standalone tool control hub 200 does not include the battery charger 120 or mobile device charger 122). Therefore, in this standalone embodiment of the tool control hub 200, the communication module 124 does not include the wired terminal connections to the battery charger 120. The standalone tool control hub 200 may be referred to as a standalone hub or a charging station hub.

In some embodiments, the standalone hub 200 is configured to and/or includes hardware to be mounted on a surface such as a wall, a cabinet, or another device such as on a garage door opener. In some embodiments, the standalone hub 200 is freestanding and configured to stand on a surface, for example, on a table, a floor, or shelf. The standalone hub 200 may have any suitable geometry, for example, cylindrical or rectilinear volumes.

In some embodiments, the standalone hub 200 includes a terminal block configured to receive power from an external power source, such as a standard 120 AC power outlet via a power cord. The terminal block directs power, via a transformer to the communication module 124 and user interface components that may include LEDs, a speaker, and one or more various sensors. The sensors may include, for example, heat sensors, motion sensors that may sense when the standalone hub 200 is being moved; pressure, deformation, or breakage sensors that sense when the standalone hub 200 is damaged. The standalone hub 200 may communicate an alert via the user interface components as are result of one of the sensors detecting a specified condition. Alternatively or in addition, the standalone hub 200 may include a battery interface and may be powered by battery cells rather than AC power.

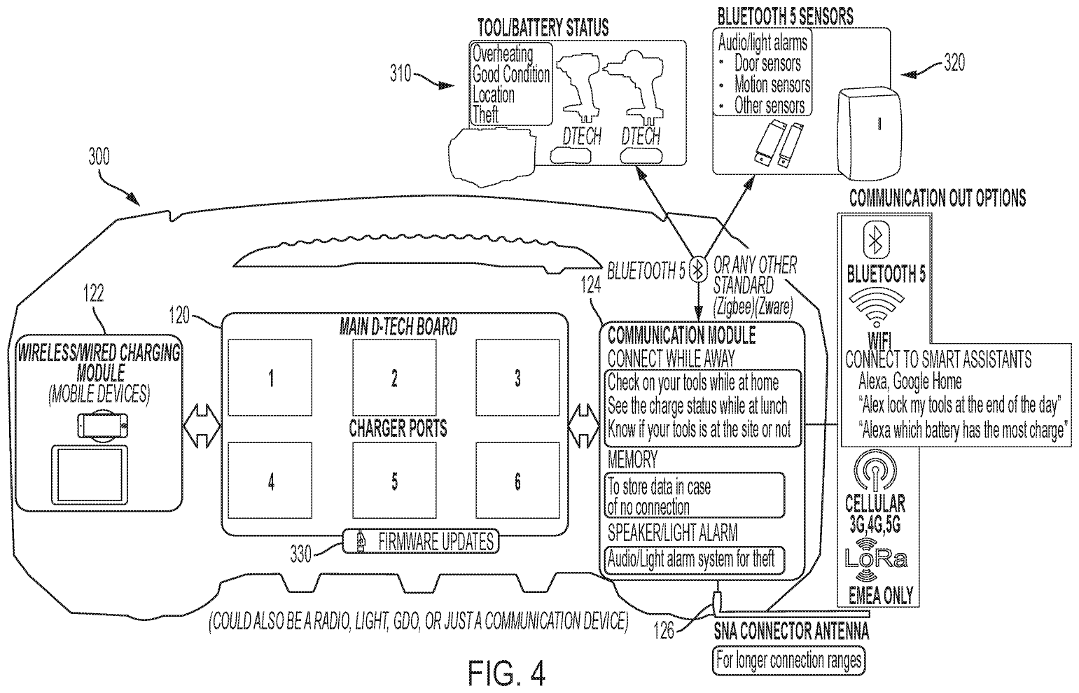

FIG. 4 is a schematic diagram illustrating a charging station hub and work site device management features. Shown in FIG. 4 are the charging station hub 300, the mobile device charging module 122, the battery charger 120, the communication module 124, the SMA or SNA connector and antenna 126. Also shown are multiple work site devices 310, multiple wireless communication enabled sensors 320, and a wired port 330.

The work site devices 310 may include, for example, power tools, battery packs, battery chargers, job site radios, lights, speakers, vacuums, fans, meters, scales, doors, locks, vehicles, and other work related equipment. The wireless communication enabled sensors 320 may include, for example, door sensors, motion sensors, heat sensors that may have audible and/or visible alarm features.

The wireline port 330 may be a type of USB port or a port based on another cable standard. The wireline port 330 may be utilized to download firmware or software updates to one or more components of the charging station hub 300, for example, to the battery charger 120.

As shown in FIG. 4, the communication module 124 communicates with the work site devices 310 and the wireless communication enabled sensors 320 via a Bluetooth connection or a connection based on any other suitable communications standard (e.g. Zigbee, Zware, LoRa, Wi-Fi, or cellular standards). The communication module 124 receives data including status information from the work site devices 310 and the wireless communication enabled sensors 320, and may store the data in memory of the communication module 124. For example, the data may indicate conditions in the work site devices 310 and the wireless communication enabled sensors 320 such as overheating, good conditions, location of the work site device work site devices 310, theft status of the work site devices 310, and detected conditions or alarm status of the sensors 320. In some embodiments, the communication module 124 communicates the data or information based on the data to a mobile user device, for example, when a user accesses the information utilizing a charging station hub software application running on the mobile user device. In this manner, the user may check on tools or see a change in status of a tool while away from the job site, and may determine whether the a tool is located at the job site.

In some embodiments, the communication module 124 communicates commands to one or more of the work site devices 310 and/or of the wireless communication enabled sensors 320 to monitor usage or to control operational aspects of the work site devices 310 and/or the wireless communication enabled sensors 320. The commands may be determined based on the data received from the work site devices 310 and/or the wireless communication enabled sensors 320. In some embodiments, the commands may be determined based on communications received from the mobile user device and input by the user via the charging station hub software application.

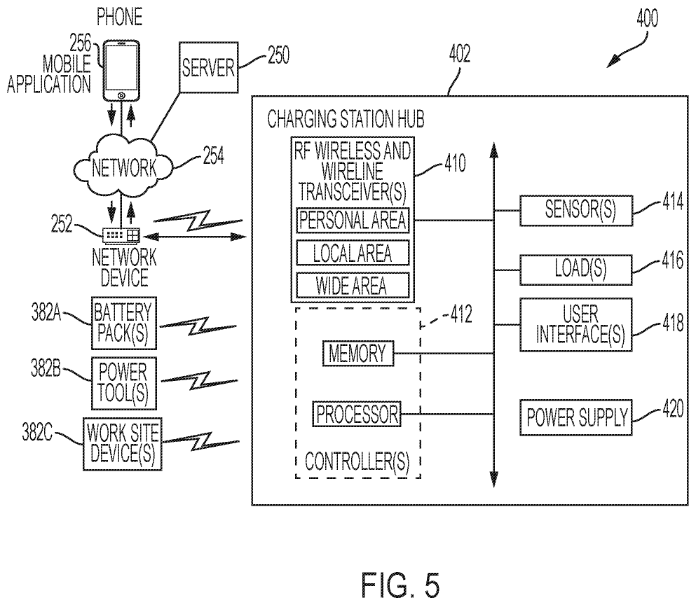

FIG. 5 is a block diagram of a charging station hub and work site device management system. Referring to FIG. 5, there is shown a work site device management system 400 including a charging station hub 402, a communication module 410, a controller 412, a sensor 414, a load 416, a user interface 418, and a power supply 420. Also shown in FIG. 5 are a server 250, a network device 252, a network 254, a mobile user device 256 and work site devices 382A, 382B, and 382C. The work site devices 382A, 382B, and 382C may be referred to as the work site devices 382.

The device management system 400 includes one or more of the work site devices 382. The work site devices 382 may include, for example, a battery pack 382A, a power tool 382B, and a sensor 382C. The work site devices 382 can be located remote from the charging station hub 402, for example, in a work site building or out of doors in a work site setting, or the work site devices 382 can be integrated within or supported by a housing of the charging station hub 402. The work site devices 382 communicate wirelessly or over wireline with the controller 412 via the communication module 410.

The controller 412 may include or be coupled to one or more memory devices and one or more electronic processors that are electrically connected via a bus to the communication module 410, the sensor 414, the load 416, the user interface 418 and the power supply 420. The controller 412 monitors and/or controls the job site devices 382 and communicates with the mobile user device 256 and the server 250. The charging station hub memory devices include, for example, a program storage area and a data storage area. The memory stores executable instructions that when executed by the charging station hub electronic processor, cause the charging station hub 402 controller to perform the functions described herein. The charging station hub 402 memory devices also store certain other information such as work site device identifiers (ID), mobile user device 256 data, expected work site device 382 operational characteristics such as current output and various voltage, current, and temperature thresholds, and the like. The charging station hub memory may also store certain information as described herein.

The communication module 410 of the charging station hub 402 comprises a plurality of transceivers that are operable to communicate utilizing any wired or wireless technology suitable for communicating with the work site devices 382, the personal mobile device 256, the server 250, the network device 252, the network 254, and other user devices. The controller 412 communicates directly via the wireless or wireline transceivers (device to device) with local devices or via the network 254 with remote devices. Wireless technologies supported by the controller 412 and/or transceivers of the communication module 410 include, for example, private area network technologies such as Bluetooth, wireless local area network (WLAN) technologies such as Wi-Fi, and wide area network technologies such as cellular technologies, low power long range (LoRa) technologies or low power wide area network (LPWAN) technologies. In some embodiments, the controller 412 and the transceivers of the communication module 410 communicate utilizing LoRa or LPWAN technologies with data rates that range from 0.3 kbps to 50 kbps and/or an adaptive data rate (ADR) scheme to manage data rate and RF outputs. The communication module 410 may include physical interfaces and may support communication protocols for communicating via wired connections and/or networks, for example, via over a USB connection or an Ethernet connection. In some embodiments, software or firmware for use in the work site devices 382 (e.g., power tools, battery packs, or battery chargers), the sensors 414, or the loads 416, may be updated, upgraded, or customized via the charging station hub 402. For example, software or firmware may be received by the controller 412 via any suitable wireless or wireline interface in the communications module 410. The software or firmware may be received from a local or remote user device or from the server 250, for example, and may be forwarded to the target device (e.g., work site device 382, sensor 414, or load 416) for the update, upgrade, or customization of the target device.

The sensor 414 of the charging station hub 402 may include one or more sensors to detect a status of the charging station hub, for example, to detect safety hazards, physical damage to the hub, theft of the hub, and/or operational impairments. For example the charging station hub may have heat, pressure, motion, or material breakage sensors. In some embodiments the sensors 414 include a microphone or camera and may receive voice commands or information about the job site environment via the microphone or camera that may be communicated to the controller 412. The controller 412 generates audible or visible alarms via the user interfaces 418 in response to specified sensor outputs to inform users or deter theft of or damage to the charging station hub 402. The controller 412 may also communicate alerts as to the status of charging station hub 402 or the job site environment via a communication module 410 to the mobile user device 256.

In some embodiments, the load 416 includes one or more work site devices 382 that are integrated or packaged within a housing of the charging station hub 402. For example, the load 416 includes the battery pack 150 and the charger 120 described with respect to FIGS. 1 and 2. In some embodiments, the charging station hub 402 may not include a load 416, for example, as in the standalone tool control hub 200 described with respect to FIG. 3.

As described with respect to FIG. 1, the standalone charging station hub 400 may be configured to receive power from an external power source.

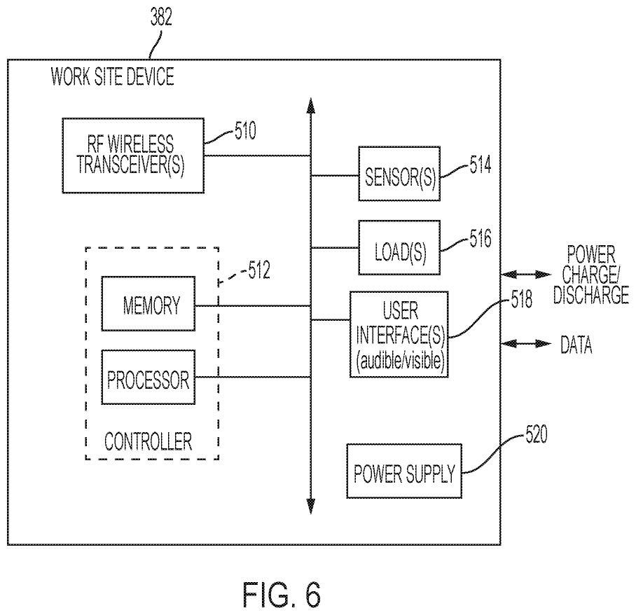

FIG. 6 is a block diagram of an example work site device for use with a charging station hub. Referring to FIG. 6, there is shown a work site device 382, a wireless transceiver 510, a controller 512, a sensor 514, a load 516, a user interface 518, and a power supply 520.

The work site device 382 may comprise any work related equipment, for example, a power tool, a battery pack, a battery charger, a device charging pad, a job site radio, a garage door opener, a light, a speaker, a vacuums, a fan, a meter, a scale, a doors, a lock, a vehicle, and a printer.

The wireless transceiver 510 includes one or more transceivers that include suitable logic, circuitry, interfaces, and or code that are operable to communicate with the charging station hub 400 via the communication module 410 or with the mobile user device 256. For example, the wireless transceivers 510 include physical interfaces and utilize communication protocols that support private area network technologies such as Bluetooth, wireless local area network (WLAN) technologies such as Wi-Fi, and wide area network technologies such as cellular technologies, low power long range (LoRa) technologies or low power wide area network (LPWAN) technologies. In some embodiments, the wireless transceivers support communication utilizing LoRa or LPWAN technologies.

The controller 512 may include or be coupled to one or more memory devices and one or more electronic processors that are electrically connected via a bus to the wireless transceivers 510, the sensor 514, the load 516, the user interface 518, and the power supply 520. The controller 512 monitors the sensor 514, controls the load 516 and/or the user interfaces 518. The controller 512 further communicates with the charging station hub 400, the mobile user device 256, and/or the server 250 via the wireless transceivers 510. The work site device memory may include a program storage area and a data storage area. The memory stores executable instructions that when executed by the work site device electronic processor, causes the work site device 382 to perform the functions described herein. In some embodiments, the work site device memory also stores certain other information such as charging station hub identifiers (ID), mobile user device 256 data, expected work site device 382 operational characteristics such as current output and various voltage, current, and temperature thresholds, and the like. The work site device memory may also store certain information as described herein.

The sensor 514 may include one or more sensors suited for the particular type of work site device 382. For example, the sensors 514 may include voltage sensors, current sensors, heat sensors, and motion sensors. The controller 512 generates audible or visible alarms via the user interfaces 518 in response to specified sensor outputs to inform users or deter theft of or damage to the work site device 382. The controller 512 may also communicate alerts as to the status of the sensors to the charging station hub 400 or to the mobile user device 256. In some embodiments, the work site devices 382 are equipped to determine its location relative to the charging station hub 400, for example, by receiving communications from or pinging the charging station hub 400. In instances when the controller 512 may be operable to lock operation of the work site device 382 and/or generate audible and/or visible alerts by activating the user interfaces 518. The user interface 518 may comprise a speaker or a light, such as an LED. In some embodiments, a work site device 382 may be equipped with a GNSS receiver to determine its location. Moreover, the controller 512 and/or the sensors 514 may be configured to detect when the work site device 382 is picked-up or moved from a work site area. For example, the work site device 382 may be configured by a user to detect displacement or attempted use, or may require an authorized input to handle the device. In such cases, in response to detecting displacement or attempted use of the work site device 382, the controller 512 may automatically communicate with the charging station hub 400, either directly (device to device) or via a network, to trigger onsite alarms, surveillance, and/or user notifications. For example, when a power tool is picked-up at a work site, the power tool may communicate an alarm to the charging station hub 402, and the controller 412 of charging station hub 402 may communicate with a security camera to capture surveillance images, cause a light to flash, or generate a siren. The charging station hub 402 may also transmit notifications to the mobile user device 256 either directly (device to device) or via the wireline or wireless network 254, and/or to the server 250.

The load 516 may comprise components of the work site device 382 that draw power from the power supply 520 to perform work of the work site device 382. For example, a load 516 in a power tool may include a motor turning a drill or a saw blade. In a battery charger, the load may comprise a charging module that supplies charge to a battery cell or battery pack.

The power supply 520 may comprise a battery pack mechanically and electrically coupled to the work site device. In some embodiments, the power supply 520 may receive power from an external power source, such as a standard 120 VAC power outlet via a power cord.

In some embodiments, the work site device 382 includes the battery pack 150 that includes battery cells. The sensors 514 may include a current sensor, a voltage sensor, and a temperature sensor. The cells may be arranged in series, parallel, or series-parallel combination. The current sensor 514 is electrically connected to the cells and detects a current flowing through the cells. The voltage sensor 514 is electrically connected to the cells and detects a voltage across the terminals of the cells. The temperature sensor 514 is, for example, a thermistor, and detects a temperature of the cells. The wireless transceivers 510 facilitate communication between the battery pack work site device 382 and external devices, for example, the communication module 124 of the charging station hub 100 or the standalone hub 200, or other devices over the communication network 254 such as the mobile user device 256.

The battery pack work site device 382 electronic processor of the controller 512 is electrically connected to the current sensor 514, the voltage sensor 514, the temperature sensor 514, the memory of the controller 512, and the wireless transceiver module 510. The electronic processor monitors the current and voltage of the cells detected by the current and voltage sensors 514. The memory of the battery pack work site device 382 may include, for example, a program storage area and a data storage area. The memory stores executable instructions that when executed by the processor, cause the battery pack work site device 382 to perform the functions described herein. The battery pack work site device 382 memory also stores certain other information regarding the battery pack, such as a battery pack identifier (ID), expected current output, various voltage, current, and temperature thresholds, and the like. The battery pack memory may also store certain tracking information as described herein.

In some embodiments, the battery pack work site device 382 is coupled to a battery charger 120 that includes a charger controller. The charger controller includes an electronic processor and memory storing instructions that are executed by the electronic processor to carry out the functionality of the charger 120 controller described herein. For example, the charger controller controls the functions of the battery charger 120 and enables communication between the charger 120 and the battery pack 150. The charger 120 further includes a charging circuit within a charger housing that is controlled by the charger controller to provide charging current to the battery pack 150 to charge the battery cells.

In some embodiments, the battery pack work site device 382 includes a dedicated terminal for communicating information to the battery charger 120 and/or to another work site device (e.g., an attached power tool). The battery pack work site device 382 further includes separate power terminals. The charger 120 or a work site device includes reciprocal power terminals and communication terminals that engage the power terminals and communication terminal of the battery pack 150. Power for charging the battery pack work site device 382 is provided from the charger 120 via the power terminals. Power for powering components of another work site device (e.g., a controller and motor) is provided from the battery pack work site device 382 to the work site device via the power terminals. Communications between charger 120 and the battery pack work site device 382 or between the battery pack work site device 382 and the other work site device occur over the communication terminals.

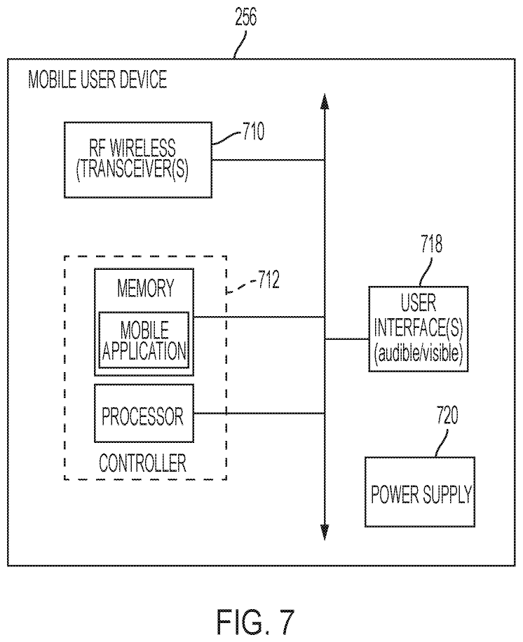

FIG. 7 is a block diagram of an example mobile user device. Referring to FIG. 7, there is shown a mobile user device 256, a wireless transceiver 710, a controller 712, a user interface 718, and a power supply 720.

The wireless transceiver 710 includes one or more transceivers comprising suitable logic, circuitry, interfaces, and or code that are operable to communicate with the charging station hub 400 via the communication module 410 or with the work site device 382 via the wireless transceivers 510. For example, the wireless transceivers 710 may include physical interfaces and utilize communication protocols that support private area network technologies such as Bluetooth, wireless local area network (WLAN) technologies such as Wi-Fi, and wide area network technologies such as cellular technologies, low power long range (LoRa) technologies or low power wide area network (LPWAN) technologies. In some embodiments, the wireless transceivers may support communication utilizing LoRa or LPWAN technologies.

The controller 712 may include or be coupled to one or more memory devices and one or more electronic processors that are electrically connected via a bus to the wireless transceivers 710, the user interface 718 and the power supply 720. The controller 712 communicates with charging station hub 400, the work site devices 382, and/or the server 250 via the wireless transceivers 710. The mobile user device memory may include a program storage area and a data storage area. The memory stores executable instructions that when executed by the work site device electronic processor, causes the work site device 382 to perform the functions described herein. The mobile user device 256 memory may store the mobile application and the mobile user device processor executes the mobile application to enable the mobile user device 256 to carry out the functionality of the mobile application described herein.

The mobile application may include a graphical user interface 718 in that, execution of the mobile application by the processor of the mobile user device 256 may generate a graphical user interface on a display of the mobile user device 256. The mobile user device 256 may convey information as described herein to a user through display on the graphical user interface 718 and may receive user input as described herein via the graphical user interface 718 (e.g., via a touch screen or hard keys of the mobile user device 256).

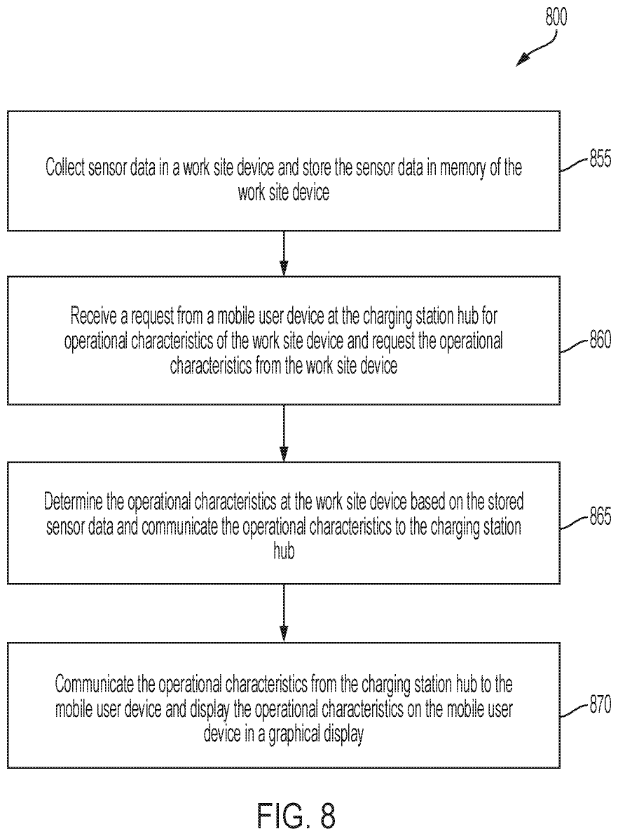

FIG. 8 is a flow chart for monitoring a work site device utilizing a charging station hub. Referring to FIG. 8, in step 855, the work site device 382 collects data from the sensor 514 while the work site device is in operation. The work site device 382 stores the sensor 514 data in the work site device memory.

In step 860, the charging station hub 402 receives a request via a wide area network connection supported by the communication module 410 from the mobile user device 256. The request is for operational characteristics of the work site device 382. The charging station hub 402 establishes a personal area connection supported by the communication interface 410 and the wireless transceivers 510 of the work site device 382, and transmits a request to the work site device 382 for the operational characteristics.

In step 865, the work site device 382 receives the operational characteristics request via the wireless transceivers 510 and the controller 512 determines the operational characteristics based on the sensor data stored in the work site device memory. The controller 512 communicates the operational characteristics to the charging station hub 502 via the personal area connection supported by the wireless transceivers 510 and the communication module 410.

In step 870, the charging station hub 100 communicates the operational characteristics to the mobile user device 256 via a wide area network connection supported by the communication module 410 to the mobile user device 256 via the network device 252 and the network 254. The mobile user device 256 displays the operational characteristics in a graphical user interface. In some embodiments, rather than receiving the operational characteristics to the mobile user device 256 in response to the request from the mobile user device 256 in step 860, the charging station hub 100 provides the operational characteristics at periodic intervals. For example, the charging station hub 100 may push (e.g., push notifications) the operational characteristics to the mobile user device 256, for example, every 2 hours. In some embodiments, the operational characteristics are pushed only during the work day and when the work site devices 382 are operational. In other embodiments, the charging station hub 100 may push the operational characteristics in response to a predetermined event. For example, the charging station hub 100 may push the operational characteristics in response to connection a battery pack for charging and/or disconnecting a battery pack from charging.

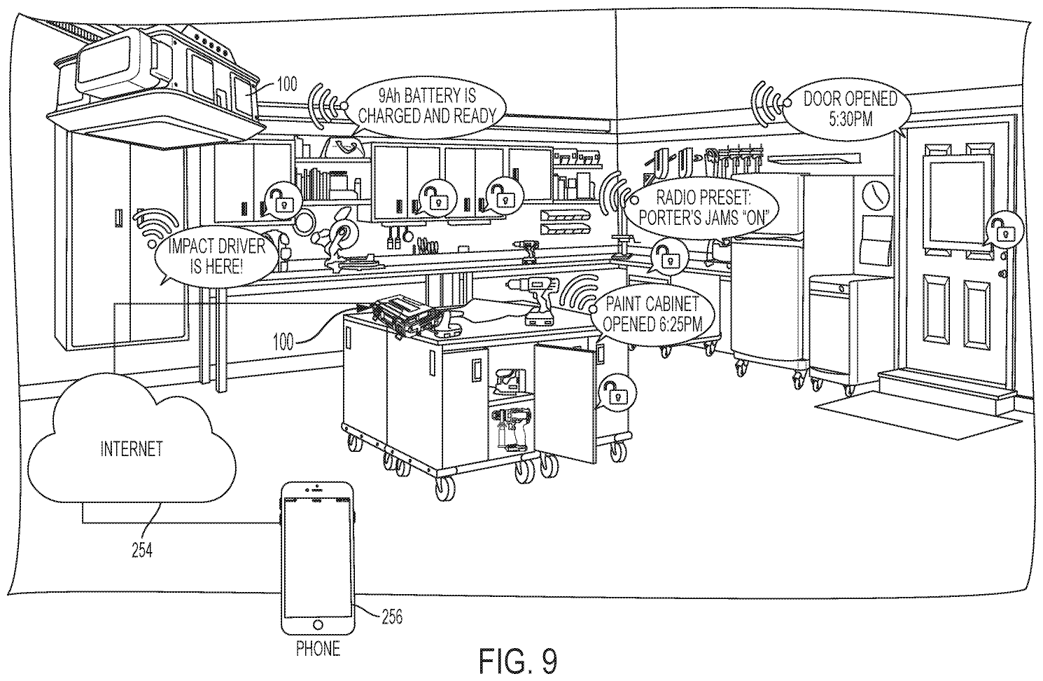

FIG. 9 illustrates a charging station hub 100 that monitors work site devices in a job site environment. Shown in FIG. 9 is the standalone charging station hub 100, the network 254, the mobile user device 256 and a plurality of work site devices. The charging station hub 100 and the plurality of work site devices are configured to communicate via Bluetooth and/or Wi-Fi connections. A first work site device communicates its location to the charging station hub 100, a job site battery pack communicates its charge level to the charging station hub 100, a job site radio communicates content settings to the charging station hub 100, and two door sensors communicate door open/close status and a door open time stamp to the charging station hub 100. The charging station hub 100 stores the work site device status data in memory. A user requests work site device status data using a graphical user interface on the mobile user device 256, which communicates the request to the charging station hub 20. The charging station hub 20 communicates the work site device status data to the mobile user device 256 and the mobile device displays the work site device status data in the graphical user interface.

In some embodiments, the work site devices 382 implements a security feature to prevent theft of the work site devices 382. The work site devices 382 are within a wireless range of the charging station hub 100 when the work site devices 382 are located in the job site. The security feature may be implemented when a work site device 382 is removed from the job site. The work site device periodically checks for a connection with the charging station hub 100. When the work site device 382 cannot connect to the charging station hub 100, the work site device 382 implements the security feature. The security feature may include locking the work site device 382 to prevent operation of the work site device, generating an audible or visible alarm, and the like. In these embodiments, the charging station hub 100 also periodically checks for a connection with the work site device 382. When the charging station hub 100 cannot establish a connection with the work site device 382, the charging station hub 100 provides an alert to the user through the mobile user device 256.

In some embodiments, the charging station hub 100 implements a security feature to prevent theft of the charging station hub 100. As described above, sensors 414 of the charging station hub 100 may include motion sensors or material breakage sensors. When an unauthorized user moves or opens the charging station hub, the motion sensor or the material breakage sensor may be triggered, which send a signal to the controller 412. The controller 412 provides an alert to the mobile user device 256 through the wireless transceiver 410. In some embodiments, the controller 412 also generates audible and/or visible alarms on the charging station hub 100.

The processors described herein are electronic processors and may be configured to carry out the functionality attributed thereto via execution of instructions stored on a compute readable medium (e.g. one of the illustrated memories), in hardware circuits (e.g., an application specific integrated circuit (ASIC) or field programmable gate array) configured to perform the functions, or a combination thereof. Additionally, unless otherwise noted, the electronic processor may take the form of a single electronic processor or multiple electronic processors arranged in any form, including parallel electronic processors, serial electronic processors, tandem electronic processors or electronic cloud processing/cloud computing configurations.

A charging station hub manages and secures various work site devices based on sensor data and operational characteristics. The work site devices are integrated in the hub, or the hub is a standalone hub and communicates wirelessly with the work site devices. Work site devices include power tools, battery packs, battery chargers, and the like. One charging station hub is equipped with battery chargers and may monitor and control charging of batteries. The charging station hub supports personal area, local area, and wide area communications. Work site device operational characteristics are transmitted to mobile devices by the charging station hub and are displayed by a mobile application. The charging station hub senses its own motion and material damage, and in response, generates audible and visible alarms and communicates problems to a user device. The charging station hub also locks operations if removed from a work site.

Although the invention has been described in detail with reference to certain preferred embodiments, variations and modifications exist within the scope and spirit of one or more independent aspects of the invention as described.

1. A charging station hub comprising:
a housing;
a communication module integrated into the housing and configured to communicate with a work site device and a mobile user device; and
a controller provided in the housing coupled to the communication module and configured to
request, via the communication module, operational characteristics from the work site device,
receive, via the communication module, the operational characteristics from the work site device, and
provide, via the communication module, the operational characteristics to the mobile user device.

2. The charging station hub of claim 1, further comprising a battery pack charger integrated into the housing.

3. The charging station hub of claim 2, wherein the work site device is a battery pack configured to be charged by the battery pack charger and wherein the operational characteristics are received from the work site device via the battery pack charger.

4. The charging station hub of claim 2, further comprising a power cord to receive power from an external power source, wherein the power from the external power source is provided to the battery pack charger.

5. The charging station hub of claim 2, wherein the battery pack charger is a six port battery pack charger configured to charge six battery pack at the same time.

6. The charging station hub of claim 1, further comprising a mobile device charging module integrated into the housing for charging the mobile user device.

7. The charging station hub of claim 1, wherein the housing further comprises:
a portable case having a base; and
a lid coupled to the base by a hinge.

8. The charging station hub of claim 7, wherein the housing further comprises:
a latching mechanism to latch the lid to the base;
a locking mechanism to lock the lid to the base; and
a carry handle.

9. The charging station hub of claim 1, further comprising a sensor to detect one of a motion or breaking of the charging site hub, wherein the controller is further configured to:
detect, using the sensor, an unauthorized motion of the charging site hub; and
generate an alarm in response to detecting the unauthorized motion.

10. The charging station hub of claim 1, wherein the controller is further configured to provide, via the communication module, an alert to the mobile user device in response to detecting the unauthorized motion.

11. The charging station hub of claim 1, wherein the controller is further configured to
receive, via the communication module, a request from the mobile user device for operational characteristics of the work site device, wherein the controller is configured to provide the operational characteristics to the mobile user device in response to receiving the request from the mobile user device.

12. The charging station hub of claim 1, wherein the controller is configured to periodically provide the operational characteristics to the mobile user device at predetermined intervals.

13. A method for monitoring and controlling devices at a work site using a charging station hub, the method comprising:
requesting, using a controller of the charging station hub via the communication module, operational characteristics from the work site device;
receiving, using the controller via the communication module, the operational characteristics from the work site device; and
providing, using the controller via the communication module, the operational characteristics to the mobile user device.

14. The method of claim 13, further comprising:
detecting, using a sensor of the charging station hub, an unauthorized motion of the charging site hub; and
generating, using the controller, an alarm in response to detecting the unauthorized motion.

15. The method of claim 14, further comprising:
providing, using the controller via the communication module, an alert to the mobile user device in response to detecting the unauthorized motion.

16. The method of claim 13, wherein the charging station hub includes a battery pack charger integrated into a housing of the charging station hub and wherein the work site device is a battery pack, the method further comprising:
charging, using the battery pack charger, the battery pack.

17. The method of claim 16, further comprising:
receiving, using a power cord of the charging station hub, power from an external power source; and
providing, the power from the external power source to the battery pack charger.

18. The method of claim 13, wherein the charging station hub includes a portable case having a base and a lid coupled to the base by a hinge, the method further comprising:
latching, using the latching mechanism, the lid to the base.

19. The method of claim 13 further comprising receiving, via a communication module of the charging station hub, a request from a mobile user device for operations characteristics of a work site device, wherein providing the operational characteristics to the mobile user device is performed in response to receiving the request from the mobile user device.

20. The method of claim 13, further comprising:
periodically providing, using the controller via the communication module, the operational characteristics to the mobile user device at predetermined intervals.
